(19) United States
(12) Patent Application Publication
(10) Pub. No.: US 2007/0206386 A1
(43) Pub. Date: Sep. 6, 2007

(54) Integrated LED Light Bars and Roof Structure for Trailers

(76) Inventors: Rodney P. Ehrlich, Monticello, IN (US); Francis S. Smidler, Lafayette, IN (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/672,768

(22) Filed: Feb. 8, 2007

Related U.S. Application Data
(60) Provisional application No. 60/778,058, filed on Mar. 1, 2006.

(51) Int. Cl. B60Q 1/00

(52) U.S. Cl. 362/485

(57) ABSTRACT

A roof structure for a trailer includes a roof sheet, a roof bow attached to the roof sheet, and a member attached to one of said roof sheet and said roof bow. The member has a plurality of LED lights attached thereto.

This application claims the domestic benefit of U.S. Provisional Application Ser. No. 60/778,058 filed on Mar. 1, 2006, which disclosure is hereby incorporated by reference.

### FIELD OF THE INVENTION

This invention is generally directed to a LED lighting structure for use with a roof structure of a trailer.

### BACKGROUND OF THE INVENTION

Prior art lighting structures used in trailer have used fluorescent and incandescent lighting. This type of lighting requires heavy dome lights and does not provide a lifetime product with lower power draw. Fluorescent and incandescent lighting also require dome light bracketry and can cause snagging issues in the loading of cargo. Fluorescent and incandescent lighting require maintenance as lights burnout and can lead to wire overloads. Furthermore, fluorescent and incandescent lighting cannot be left on for extended periods of time without a real concern that they may cause a fire.

In addition, fluorescent and incandescent lighting typically do not respond well to cold temperatures. As the interior of a refrigerated semi-trailer at the ceiling thereof will typically have a temperature of −20 degrees Fahrenheit, fluorescent and incandescent lighting have been known to fail or malfunction because of the cold temperatures.

The present invention provides a lighting structure which overcomes the problems presented in the prior art and which provides additional advantages over the prior art, such advantages will become clear upon a reading of the attached specification in combination with a study of the drawings.

### SUMMARY OF THE INVENTION

Briefly, the present invention discloses a roof structure for a trailer. The roof structure includes a roof sheet, a roof bow attached to the roof sheet, and a member attached to one of said roof sheet and said roof bow. The member has a plurality of LED lights attached thereto.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a rear perspective view of a trailer which incorporates the features of a first embodiment of the invention;

FIG. 2 is a partial perspective view of a base rail, a sidewall and a roof structure of the trailer of FIG. 1;

FIG. 3 is a perspective view of components used to form a LED light bar used in the first embodiment of the present invention;

FIG. 4 is a cross-sectional view of components used to form the LED light bar used in the first embodiment of the present invention;

FIG. 5 is a perspective of components used to form the LED light bar used in the first embodiment of the present invention;

FIG. 6 is a cross-sectional view of components used to form the LED light bar used in the first embodiment of the present invention and a roof bow;

FIG. 7 is a cross-sectional view of components used to form the LED light bar used in the first embodiment of the present invention and the roof bow;

FIG. 8 is a cross-sectional view of the LED light bar used in the first embodiment of the present invention and the roof bow;

FIG. 9 is a perspective view of a portion of the roof structure which incorporates the features of the first embodiment of the present invention;

FIG. 10 is a cross-sectional view of the LED light bar used in the first embodiment of the present invention attached to the roof structure;

FIG. 11 is a rear perspective view of a trailer which incorporates the features of a second embodiment of the invention;

FIG. 12 is a partial cross-sectional view of a sidewall and a roof structure of the trailer of FIG. 11;

FIG. 13 is a perspective view of a portion of the roof structure in the trailer of FIG. 11;

FIG. 14 is a cross-sectional view of components used to form the LED light bar used in the second embodiment of the present invention;

FIG. 15 is a cross-sectional view of the LED light bar used in the second embodiment of the present invention and the roof bow;

FIG. 16 is a end plan view of the roof structure used in the second embodiment of the present invention;

FIG. 17 is a rear perspective view of a trailer which incorporates the features of a third embodiment of the invention;

FIG. 18 is a partial perspective view of a base rail, a sidewall and a roof structure of the trailer of FIG. 17;

FIG. 19 is a perspective view of a portion of the roof structure in the trailer of FIG. 17;

FIG. 20 is a cross-sectional view of components used to form the LED light bar used in the third embodiment of the present invention;

FIG. 21 is a cross-sectional view of the LED light bar used in the third embodiment of the present invention;

FIG. 22 is a cross-sectional view of the LED light bar used in the third embodiment of the present invention and a portion of the roof structure;

FIG. 23 is a rear perspective view of a trailer which incorporates the features of a fourth embodiment of the invention;

FIG. 24 is a perspective view of a portion of the roof structure in the trailer of FIG. 23;

FIG. 25 is a perspective view of components used to form a LED light bar used in the third embodiment of the present invention;

FIG. 26 is a perspective of components used to form the LED light bar used in the third embodiment of the present invention;

FIG. 27 is a cross-sectional view of the LED light bar used in the third embodiment of the present invention; and

FIG. 28 is a cross-sectional view of the LED light bar used in the third embodiment of the present invention and a portion of the roof structure.

### DETAILED DESCRIPTION OF THE ILLUSTRATED EMBODIMENTS

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein.

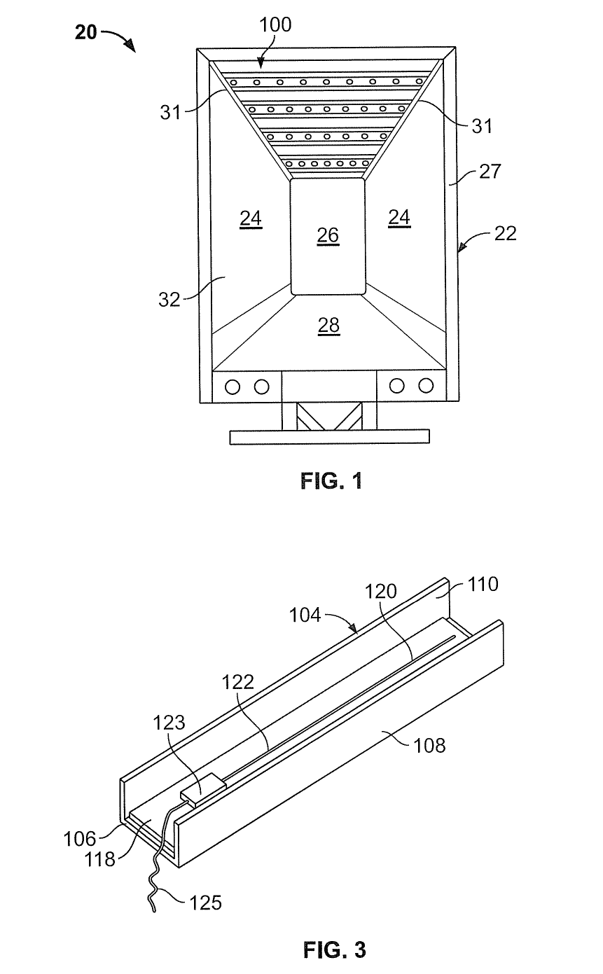

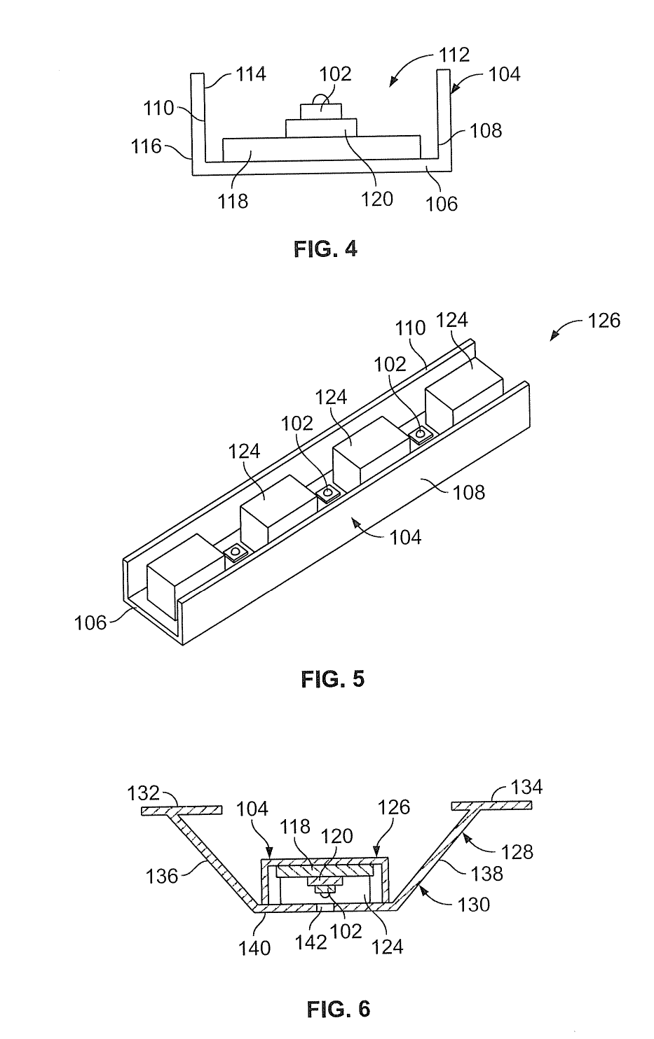

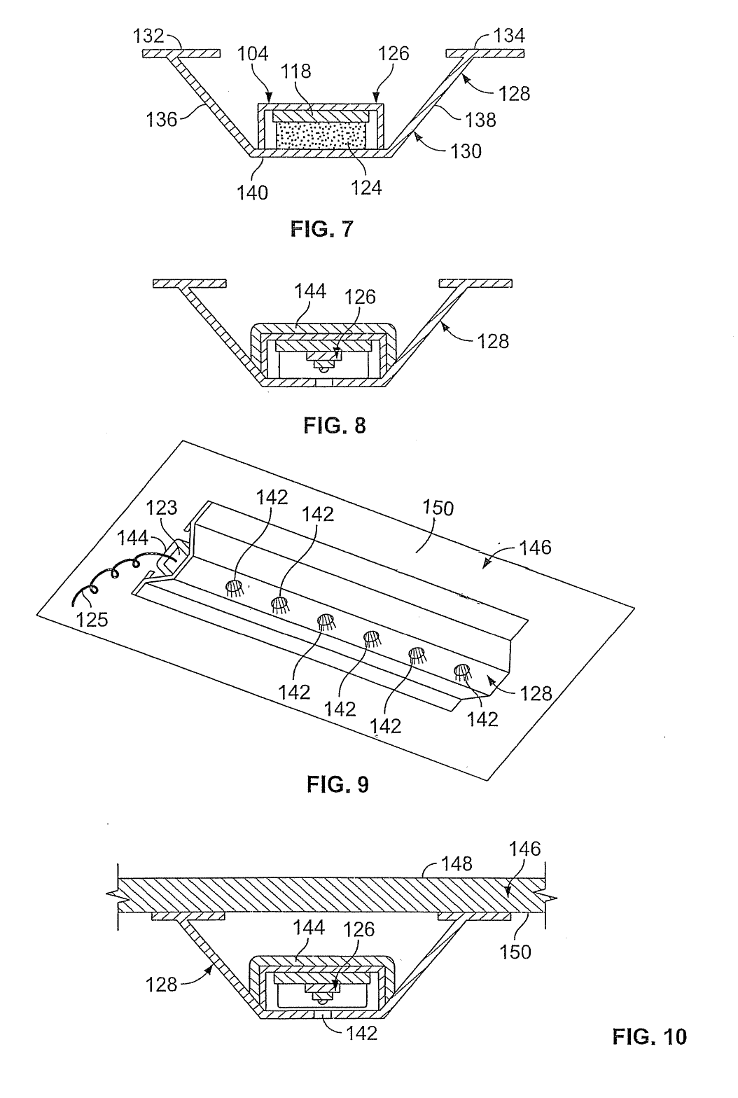

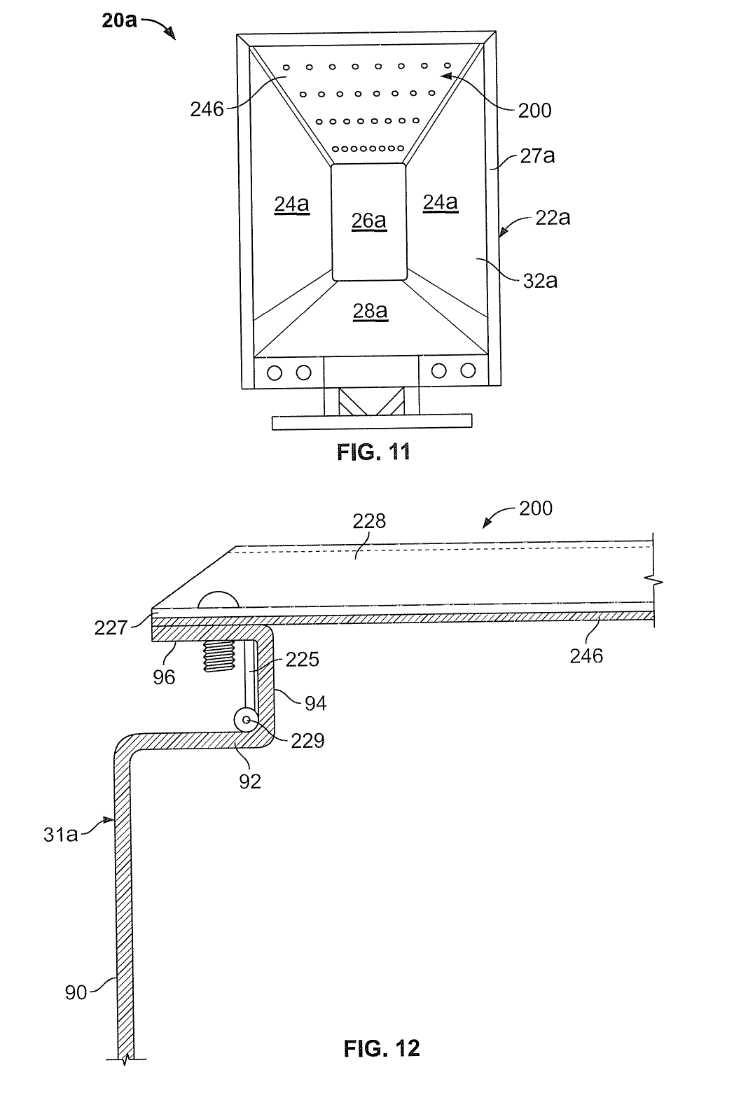

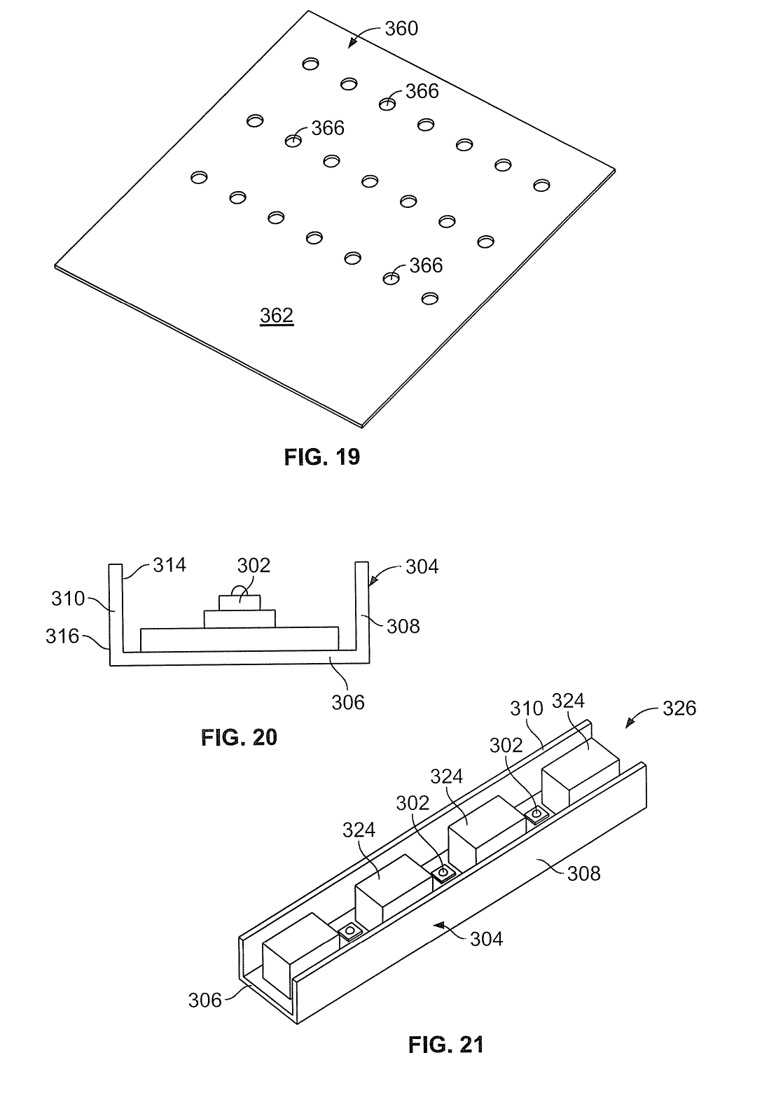

First and second embodiments of a roof assembly 100 and 200 for a dry freight trailer 20 and 20a are provided. The first embodiment of the roof assembly 100 is described and illustrated with reference to FIGS. 1-10, with the reference numerals being in the one hundreds. The second embodiment of the roof assembly 200 is described and illustrated with reference to FIGS. 11-16, with the reference numerals being in the two hundreds. In addition, third and fourth embodiments of a roof assembly 300 and 440 for a trailer, which may be a dry freight trailer or a refrigerated trailer, are provided. The third embodiment of the roof assembly 300 is described and illustrated with reference to FIGS. 17-22, with the reference numerals being in the three hundreds. The fourth embodiment of the roof assembly 400 is described and illustrated with reference to FIGS. 23-28, with the reference numerals being in the four hundreds. Like reference numerals denote like elements. It is also to be understood that the drawings are not necessarily drawn to scale.

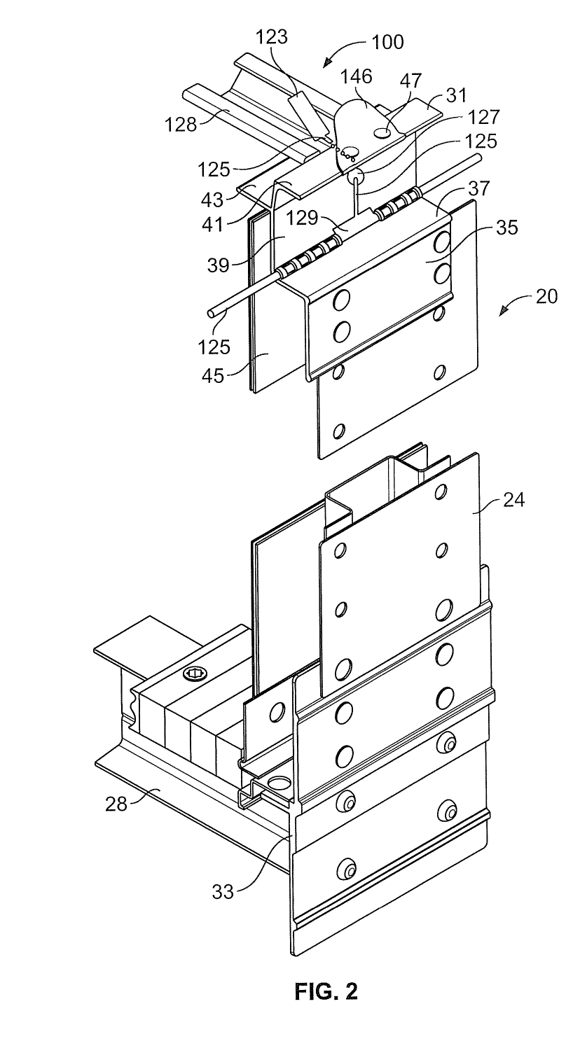

FIGS. 1 and 2 illustrate the trailer 20 having a roof assembly 100 which incorporates features of the present invention. The trailer 20 generally includes a body 22 formed from opposite sidewalls 24, a front wall 26, a front frame (not shown) to which the front wall 26 is attached, rear doors (not shown), a rear frame 27, the roof assembly 100, and a floor assembly 28. A landing gear (not shown) and an undercarriage (not shown) are attached to the floor assembly 28 by known means. The roof assembly 100 and an upper portion of the sidewalls 24 are secured to top rails 31 in a known manner. The floor assembly 28 and a lower portion of the sidewalls 24 are secured to bottom rails 33 in a known manner. The front end of the sidewalls 24 and the front wall 26 are connected by the front frame. The rear end of the sidewalls 24 are connected to the rear frame 27. The sidewalls 24 can be formed of foamed material between sheets, sheet and post, composite plates, or by other known sidewall constructions. The rear doors are hingedly attached to the body 22 by known means and seat within the rear frame 27 when the rear doors are closed. The trailer 20 may be connected to a tractor (not shown) by conventional means, such as a fifth wheel.

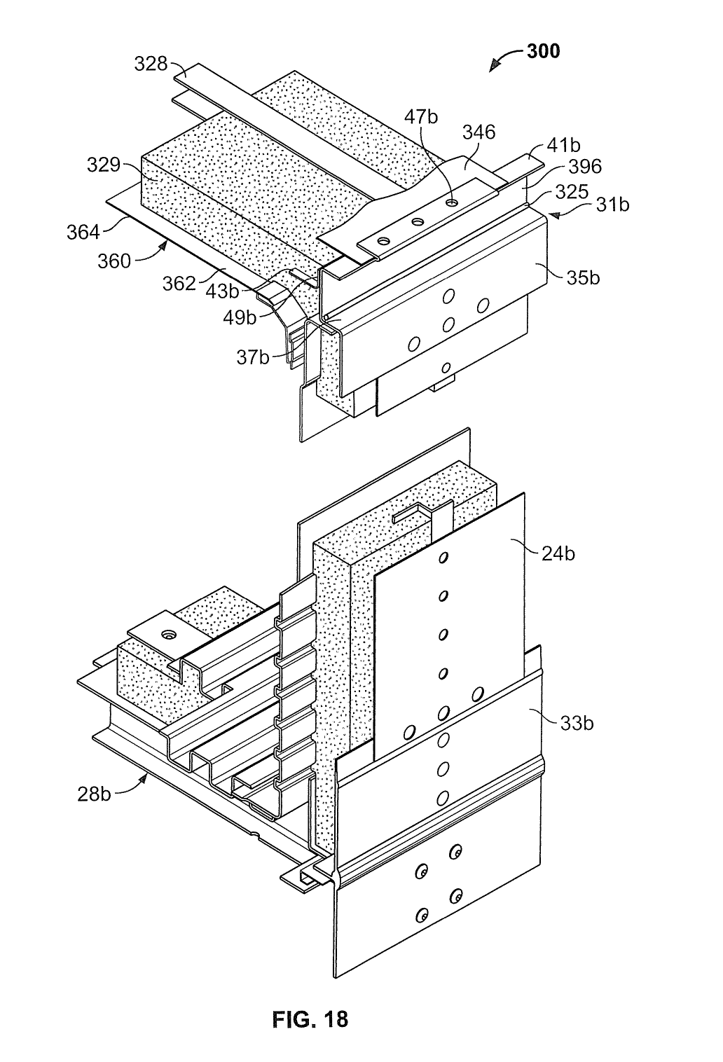

Each top rail 31 includes a first vertical wall 35 which is connected to the sidewalls 24, a second horizontal wall 37 which is perpendicular to the first vertical wall 35 and extends inwardly towards the interior of the trailer 20, a third vertical wall 39 which is perpendicular to the second wall 37 and parallel to the first wall 35, a fourth horizontal wall 41 which is perpendicular to the third wall 39, parallel to the second wall 37 and extends outwardly from the interior of the trailer 20, and a flange 43 which extends inwardly towards the interior of the trailer 20 from the third wall 39. The second wall 37 covers the top end of the sidewall 24. If desired, the top rail 31 can be made as a two-piece assembly as shown in FIG. 18. A sidewall liner 45 can be provided which extends from the floor assembly 28 and is connected to the inner surface of the third wall 39 by suitable means.

Attention is invited to FIGS. 2-10 which shows the specifics of the first embodiment of the roof assembly 100 for a dry freight trailer 20. The roof assembly 100 is provided with a plurality of LED lights 102 for lighting an interior 32 of the trailer 22, which is defined between the sidewalls 24, the front wall 26, the rear doors, the roof assembly 100 and the floor assembly 28.

The roof assembly 100 includes a plurality of spaced apart roof bows 128, a LED light bar 126 provided in at least one of the roof bows 128, and a roof sheet 146. The roof bows 128 are secured to the top rail 31 by known means, such as rivets (not shown) extending through the roof bow 128 and the flange 43. The roof sheet 146 sits on top of the roof bows 128 and the fourth wall 41 of the top rail 31. The roof sheet 146 is secured to the top rails 31 by known means, such as rivets 47 extending through the roof sheet 146 and the fourth wall 41. The roof sheet 146 is secured to the roof bows 128 by known means, such as adhesive.

Each LED light bar 126 includes an elongated member 104 which is sized to generally extend from one of the sidewalls 24 to the other sidewall 24. The number of elongated members 104 provided in the trailer 20 may vary as desired, but is typically dependent upon the length of the trailer 20, defined as the distance from the front wall 26 to the rear doors (not shown), as well as the amount of light which is desired to be emitted into the interior 32 of the trailer 20. As each elongated member 104 is preferably identical in configuration and structure, only a single elongated member 104 will be described herein with the understanding that each elongated member 104 is formed and configured in an identical manner.

The elongated member 104, preferably has a length of ninety-six (96) inches, a width of one and one-half (1.5) inches, a height of one-quarter (0.25) of an inch, and a constant thickness throughout the length, width and height thereof. Of course, it is to be understood, that the elongated member 104 may be configured to have varying sizes depending on the size and type of trailer 20 in which it is to be used. The elongated member 104 is preferably formed of extruded aluminum, but may be formed of any other material which is either conductive or non-conductive, but preferably must be lightweight and strong.

The elongated member 104 is preferably U-shaped such that it has a base 106 and two leg portions 108 and 110 which extend upwardly from the ends of the base 106 along a length thereof, and a channel 112 which is provided between the base 106 and the leg portions 108 and 110. The elongated member 104 has an interior surface 1114, defined as the surfaces of the base 106 and the leg portions 108 and 110 which define the channel 112, and an exterior surface 116.

If the elongated member 104 is formed of a conductive material, such as the extruded aluminum of the preferred embodiment, the elongated member 104 acts as heat sink. An insulator 118 is applied to the interior surface 114 of the base 106 along the length of the elongated member 104. The insulator 118 is preferably applied in a thin layer (exaggerated in the drawings for clarity in illustration) over the base 106 and is a non-conductive material, such as paint, tape or plastic. Although not illustrated, the insulator 118 may also be applied to at least a portion of the leg portions 108 and 110 if desired. Where the elongated member 104 is formed of a non-conductive material, the insulator 118 need not be applied to the interior surface 114 of the base 106 or the leg portions 108 and 110.

A circuit 120 (exaggerated in the drawings for clarity in illustration) is provided, such as by printing, oil either the insulator 118 or the interior surface 114 of the base 106, as appropriate, along the length of the elongated member 102 by known means. Wiring 122 is connected to the circuit 120 at one of the two ends of the elongated member 104, and is connected to a connector 123 which is provided proximate to an end of the elongated member 102.

The LED lights 102 are secured to either the insulator 118, or to one or more of the base 106 and leg portions 108 and 110 of the elongated member 104 if non-conductive, in a known manner, and the LED lights 102 are electrically connected with the circuit 120. The LED lights 102 are preferably equally spaced from one another along the length of the elongated member 104, but the spacing between the LED lights 102 may be varied as desired. The LED lights 102 preferably extend a distance from the circuit 120 such that they are provided within or are even with the confines of the channel 112 of the elongated member 104, as illustrated in FIG. 6, but may extend beyond the confines of the channel 112 if desired, e.g., such that the LED lights 102 extend further from the base 106 than do the leg portions 108 and 110.

Pieces of adhesive 124, preferably double pressure sensitive adhesive, such as a foamed tape, for instance a 3M® Very High Bond (VHB) Tape, are secured to either the insulator 118 or the base 106, as appropriate, within the channel 112 between each of the LED lights 102, as illustrated in FIG. 5.

The LED light bar 126 includes the combination of the elongated member 104, the insulator 118 (if provided), the circuit 120, wiring 122 and connector 123, the LED lights 102, and the pieces of double pressure sensitive adhesive 124. The roof assembly 100 can include a plurality of LED light bars 126, the number of which are dependent upon the number of roof bows 128.

Each roof bow 128 spans the width of the interior 32 of the trailer 20. The roof bows 128 are provided at predetermined spaced apart positions along the length of the trailer 20. Each roof bow 128 may be identically formed and may take a variety of shapes, provided the roof bow 128 covers the LED light bar 126 mounted therein. The structure of an exemplar construction of only a roof bow 128 is shown in the drawings and described herein. The roof bow 128 has a middle section 130 that has flat end sections 132 and 134 extending outwardly from the opposite ends of the middle section 130. As best shown in FIG. 6, the middle section 130 has a first wall 136 which extends downwardly at an angle from the flat end section 132, a second wall 138 which extends downwardly at an angle from the opposite flat end section 134, and a third wall 140 which connects the lower ends of the first and second walls 136 and 138 together. The third wall 140 is provided with a plurality of apertures 142 therethrough. The apertures 142 are provided at spaced intervals to one another, preferably at three (3) or four (4) inches. The interval at which the apertures 142 are spaced from one another is dependent upon the interval at which the LED lights 102 are spaced from one another within the LED light bars 126. The apertures 142 may be formed in the third wall 140 of the roof bow 128 by punching or drilling, or any other acceptable manner known in the art. The apertures 142 are preferably one-quarter (0.25) of an inch in diameter. It is to be understood that other shapes of the roof bows 128 may be provided, including, but not limited to, a hat section.

As illustrated in FIG. 6, a LED light bar 126 is positioned against the third wall 140 of the middle section 130 of the roof bow 128, between the first and second walls 136 and 138. The leg portions 108 and 100 of the LED light bar 126 contact the third wall 140 such that the pieces of double pressure sensitive adhesive 124 are provided between and contact the third wall 140 and the base 106 of the elongated member 104. The LED lights 102 on the LED light bar 126 are aligned with the apertures 142 provided through the third wall 140 such that the LED lights 102 are visible through the apertures 142 of the third wall 140. Depending on the LED lights 102 used, the LED lights 102 may preferably be recessed back from the apertures 142, as illustrated in FIG. 6, or may extend into the apertures 142, but preferably do not extend out of the apertures 142, as they may then be in position for damage as they would be positioned within the interior 32 of the trailer 20.

The LED light bar 126 is covered by an adhesive 144, preferably tape, such as polypropylene, vinyl or mylar tape, as illustrated in FIG. 8. The adhesive 144 covers the entire exterior surface 116 of the elongated member 104 of the LED light bar 126. All of the LED light bars 126 are covered in this manner.

The roof sheet 146 has top and bottom surfaces 148 and 150 and is preferably formed of a metal sheet or a strong, thermoset or thermoplastic resin glass or other fiber-reinforced material, such as KEMLITE® material or BULITEX® material or the like. The bottom surface 150 of the roof sheet 146 will be generally exposed to the interior 32 of the trailer 20.

As illustrated in FIG. 10, the bottom surface 150 of the roof sheet 146 sits on the flat end sections 132 and 134 of the roof bows 128. The roof sheet 146 may be secured to the roof bows 128 in a manner known in the art, such as by adhesive. The LED light bars 126 and the adhesive 128 are positioned between the bottom surface 150 of the roof sheet 146 and the middle section 130 of the roof bows 128. The roof sheet 146 is secured to the top rails 31 in a manner known in the art.

The connector 123 is connected to wiring 125 which extends outwardly from the end of the elongated member 104, as illustrated in FIG. 3. As shown, the wiring 125 extends through a grommeted aperture 127 provided through the third wall 39 of the top rail 31 and down the third wall 39. A molded T-shaped connector 129 is secured to the top rail 31 in a groove provided at the juncture between the third wall 39 and the second wall 37. As shown, the wiring 125 runs along the outer surface of the top rail 31 along the groove to a power source (not shown), which may be positioned appropriately on or in the trailer 20, or on or in a cab (not shown) via the seven-way connector (not shown) which is used to pull the trailer 20. With the power source supplying power to the wiring 122, the LED lights 102 are caused to emit light therefrom which is directed into the interior 32 of the trailer 20 in order to brighten the interior 32 of the trailer 20.

It should be noted that, if desired, the elongated member 104 need not be provided with the leg portions 108 and 110. The adhesive 144 would cover the exterior surface 116 of the base 106 of the elongated member 104 and the gap between the base 106 and the roof bow 128, and would close off accessibility to the LED light bars 126.

FIGS. 11 and 12 illustrate the trailer 20a having a roof assembly 200 which incorporates features of the present invention. The trailer 20a generally includes a body 22a formed from opposite sidewalls 24a, a front wall 26a, a front frame (not shown) to which the front wall 26a is attached, rear doors (not shown), a rear frame 27a, the roof assembly 200, and a floor assembly 28a. A landing gear (not shown) and an undercarriage (not shown) attached are attached to the floor assembly 28a by known means. The roof assembly 200 and an upper portion of the sidewalls 24a are secured to top rails 31a in a known mariner. The floor assembly 28a and a lower portion of the sidewalls 24a are secured to bottom rails (not shown) in a known manner. The front end of the sidewalls 24a and the front wall 26a are connected by the front frame. The rear end of the sidewalls 24a are connected to the rear frame 27a. The sidewalls 24a can be formed of foamed material between sheets, sheet and post, composite plates, or by other known sidewall constructions. The rear doors are hingedly attached to the body 22a by known means and seat within the rear frame 27a when the rear doors are closed. The trailer 20a may be connected to a tractor (not shown) by conventional means, such as a fifth wheel.

Each top rail 31a is formed of a first vertical wall 90, a second wall 92 which is perpendicular to the first vertical wall 90, a third wall 94 which is perpendicular to the second wall 92 and parallel to the first wall 90, and a fourth wall 96 which is perpendicular to the third wall 94 and parallel to the second wall 92. An upper end of the sidewall 24a is connected to the first wall 90 by suitable means. The second wall 92 extends inwardly toward the interior of the trailer and covers the top end of the sidewall 24a. The fourth wall 96 extends outwardly from the interior of the trailer.

Attention is now invited to FIGS. 12-16 which shows the second embodiment of the roof assembly 200. The roof assembly 200 is provided with a plurality of LED lights 202 for lighting an interior 32a of the trailer 22a, which is defined between the sidewalls 24a, the front wall 26a, the rear doors, the roof assembly 200 and the floor assembly 28a.

The roof assembly 200 includes a plurality of spaced apart roof bows 228, a LED light bar 226 provided in at least one of the roof bows 228, and a roof sheet 246. The roof sheet 246 sits underneath the roof bows 228 and the roof sheet 246 and roof bows 228 are secured to the top rails 31a. This structure is shown in co-pending U.S. application Ser. No. 11/563,796, filed on Nov. 28, 2006, claiming benefit of provisional application Ser. No. 60/748,726 filed on Dec. 8, 2005, which disclosure in its entirety is herein incorporated by reference.

Each LED light bar 226 is identical in configuration and construction to the LED light bars 126 utilized in the first embodiment of the roof assembly 100. Therefore, the configuration and construction of the LED light bars 226 will not again be repeated herein for brevity purposes, but it is to be understood that reference numerals in the two hundreds denoting elements of the LED light bars 226 utilized in the second embodiment of the roof assembly 200 are identical to like reference numerals in the one hundreds denoting elements of the LED light bars 126 utilized in the first embodiment of the roof assembly 100.

The roof bows 228 are identical in configuration to the roof bows 128 utilized in the first embodiment of the roof assembly 100, except for the differences discussed herein. Therefore, the configuration of the roof bows 228 will not again be repeated herein for brevity purposes, but it is to be understood that reference numerals in the two hundreds denoting elements of the roof bows 228 utilized in the second embodiment of the roof assembly 200 are identical to like reference numerals in the one hundreds denoting elements of the roof bows 128 utilized in the first embodiment of the roof assembly 100. In this second embodiment, the roof bows 228 are flipped 180 degrees from that shown in the first embodiment. Accordingly, the first wall 236 of the middle section 230 extends upwardly at an angle from the flat end section 232, the second wall 238 extends upwardly at an angle from the opposite flat end section 234, and the third wall 240 connects the upper ends of the first and second walls 236 and 238 together. The third wall 240 also does not have any apertures provided therethrough.

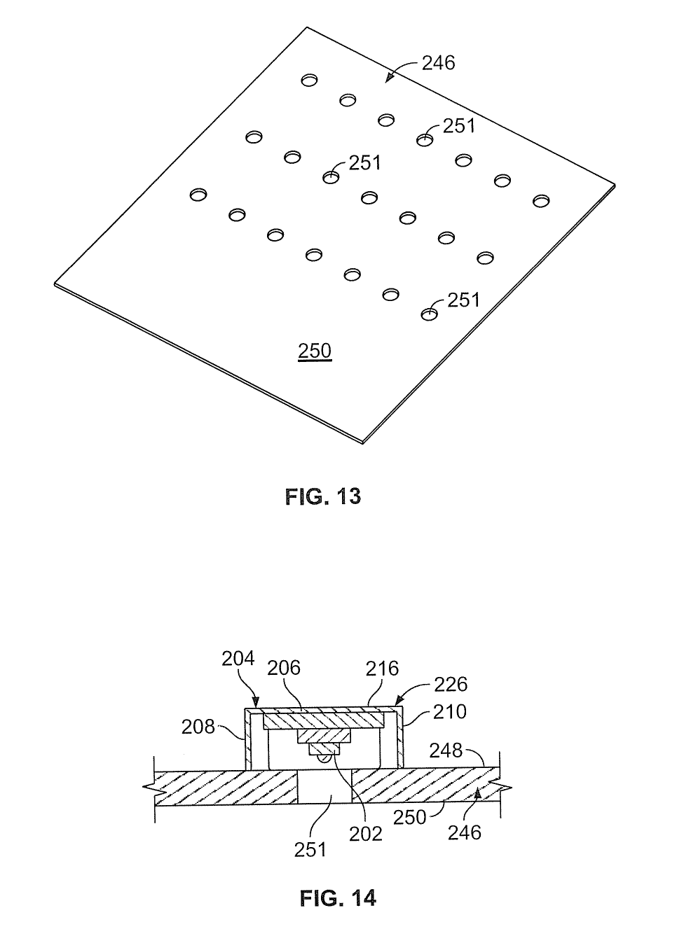

The roof sheet 246 has top and bottom surfaces 248 and 250 and spans the length and width of the interior 32a of the trailer 20a. The roof sheet 246 is preferably formed of a metal sheet or a strong, thermoset or thermoplastic resin glass or other fiber-reinforced material, such as KEMLITE® material or BULITEX® material or the like. The bottom surface 250 of the roof sheet 246 is generally exposed to the interior 32a of the trailer 20a. The roof sheet 246 is provided with a plurality of apertures 251 therethrough, as illustrated in FIG. 13, with the apertures 251 preferably being provided in rows which extend along the width of the roof sheet 246; the rows are spaced apart from each other at intervals which correspond to the spacing of the roof bows 228. The apertures 251 within each row are provided at spaced intervals to one another which correspond to the intervals at which the LED lights 202 are spaced from one another within the LED light bars 226. The apertures 251 may be formed in the roof sheet 246 by punching or drilling, or by any other acceptable manner known in the art.

Each LED light bar 226 is positioned against the top surface 248 of the roof sheet 246, as illustrated in FIG. 14, and aligned with one of the rows of apertures 251 of the roof sheet 246. The leg portions 208 and 210 of the LED light bar 226 contact the top surface 248 of the roof sheet 246 such that the pieces of double pressure sensitive adhesive 224 are provided between and contact the top surface 248 of the roof sheet 246 and the base 206 of the elongated member 204. The LED lights 202 align with the apertures 251 in the row such that the LED lights 202 are visible through the apertures 251 from the bottom surface 250 of the roof sheet 246. Depending on the LED lights 202 used, the LED lights 202 may preferably be recessed back from the apertures 251, as illustrated in FIG. 14, or may extend into the apertures 251, but preferably do not extend out of the apertures 251 and into the interior 32 of the trailer 20, as they may then be in position for damage as they would be positioned within the interior 32 of the trailer 20.

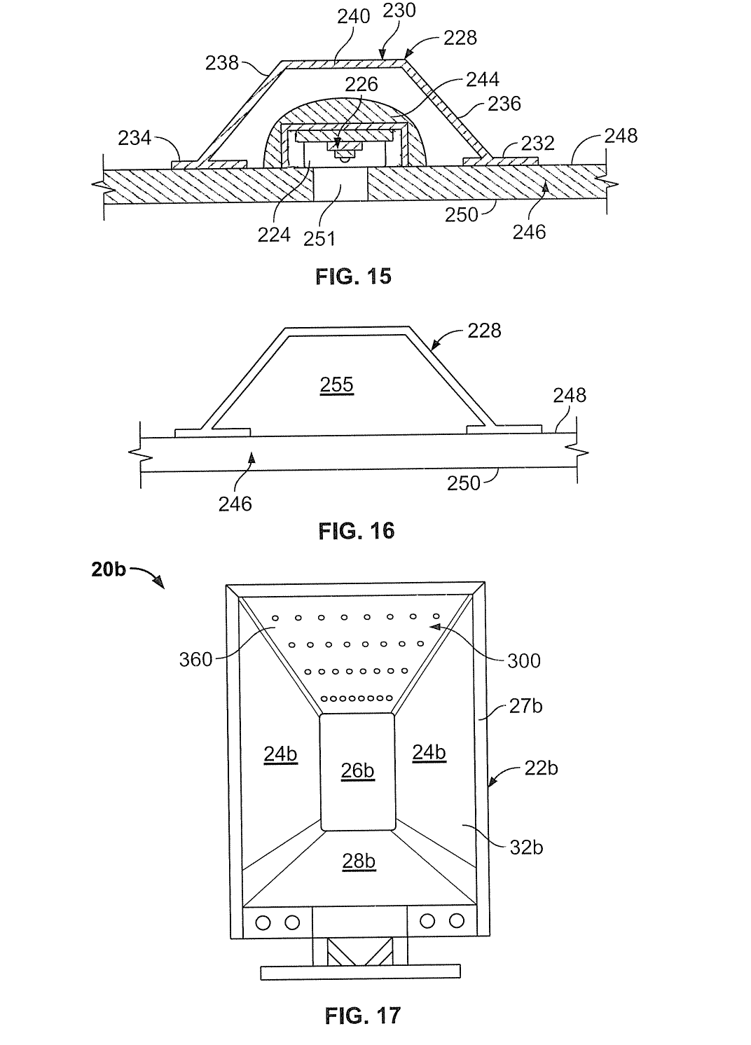

The LED light bar 226 is covered by an adhesive 244, preferably tape, such as polypropylene, vinyl or mylar tape, as illustrated in FIG. 15. All of the LED light bars 226 are covered and secured to the top surface 248 in this manner.

The roof bows 228 are secured to the roof sheet 246 and to the top rails 31 in the manner described and illustrated in co-pending U.S. application Ser. No. 11/563,796. The roof bows 228 are secured to the top surface 248 of the roof sheet 246 in such a manner that the roof bow 228 covers one of the LED light bars 226, which is covered by the adhesive 244, as illustrated in FIG. 15. The flat end sections 232 and 234 are positioned against the top surface 248 of the roof sheet 246 on either side of the LED light bars 226 and the adhesive 244. The middle section 230 extends upwardly and over the LED light bars 226 and the adhesive 244. It should be noted that roof bows 244 could be secured to the top surface 248 of the roof sheet 246 in areas where the LED light bars 226 and adhesive 244 are not provided.

The connector (shown as element 123 in FIG. 3) is connected to wiring 225 which extends outwardly from the end of the elongated member 204. As shown, the wiring 225 extends through grommeted apertures 227 provided through the roof sheet 246 and the fourth wall 96 of the top rail 31a and down the third wall 94. A molded T-shaped connector 229 is secured to the top rail 31a in a groove provided at the juncture between the second wall 92 and the third wall 94. The wiring 225 runs along the outer surface of the top rail 31a along the groove to a power source (not shown), which may be positioned appropriately on or in the trailer 20a, or on or in a cab (not shown) via the seven-way connector (not shown) which is used to pull the trailer 20a. With the power source supplying power to the wiring, the LED lights 202 are caused to emit light therefrom which is directed into the interior 32a of the trailer 20a in order to brighten the interior 32a of the trailer 20a.

Because the roof bows 228 are exposed to the elements, the roof bows 228 that surround the LED light bars 226 are preferably closed off at their ends by a cap 255 which may be formed of metal plate sealed to the end of the roof bow 228, or by a foam material injected into the ends of the roof bows 228, as illustrated in FIG. 16. The cap 255 creates a water tight seal which prevents moisture from coming into contact with the adhesive 244 and thus, the LED light bars 226. Other water tight caps are within the scope of the present invention.

It should be noted that, if desired, the elongated member 204 need not be provided with the leg portions 208 and 210. In this instance, the pieces of double pressure sensitive adhesive 224 provided in the LED light bars 226 would contact the top surface 248 of the roof sheet 246. The adhesive 244 would cover the exterior surface 216 of the base 206 of the elongated member 204 and would close off accessibility to the LED light bars 226.

Attention is invited to FIGS. 17-22 which shows the specifics of the third embodiment of the roof assembly 300. This roof assembly 300 is used in a trailer 20b, which may be a dry freight trailer or a refrigerated trailer. The roof assembly 300 is provided with a plurality of LED lights 302 for lighting an interior 32b of the trailer 20b, which is defined between the sidewalls 24b, the front wall 26b, the rear doors, the roof assembly 300 and the floor assembly 28b.

FIGS. 17 and 18 illustrate the trailer 20b having a roof assembly 300 which incorporates features of the present invention. The trailer 20b generally includes a body 22b formed from opposite sidewalls 24b, a front wall 26b, a front frame (not shown) to which the front wall 26b is attached, rear doors (not shown), a rear frame 27b, the roof assembly 300, and a floor assembly 28b. A landing gear (not shown) and an undercarriage (not shown) attached are attached to the floor assembly 28b by known means. The roof assembly 300 and an upper portion of the sidewalls 24b are secured to top rails 31b (only one of which is shown) in a known manner. The floor assembly 28b and a lower portion of the sidewalls 24b are secured to bottom rails 33b (only one of which is shown) in a known manner. The front end of the sidewalls 24b and the front wall 26b are connected by the front frame. The rear end of the sidewalls 24b are connected to the rear frame 27b. The sidewalls 24b can be formed of foamed material between sheets, sheet and post, composite plates, or by other known sidewall constructions. The rear doors are hingedly attached to the body 22b by known means and seat within the rear frame 27b when the rear doors are closed. The trailer 20b may be connected to a tractor (not shown) by conventional means, such as a fifth wheel.

Each top rail 31b is preferably formed of a lower piece and an upper piece. The lower piece includes a first vertical wall 35b which is connected to the sidewalls 24b, a second horizontal wall 37b which is perpendicular to the first vertical wall 35b and extends inwardly towards the interior of the trailer 20b and a third vertical wall 39b which is perpendicular to the second wall 37b and parallel to the first wall 35b. The second piece includes a first horizontal wall 41b which is perpendicular to the third wall 39 of the lower piece, parallel to the second wall 37b of the lower piece and extends outwardly from the interior of the trailer 20b, a second vertical wall 49b which overlaps an upper end of the third wall 39 of the lower piece, and a flange 43b which extends inwardly towards the interior of the trailer 20b from the vertical wall 49b. The second wall 37b covers the top end of the sidewall 24b. If desired, the top rail 31b can be made as a one-piece assembly as shown in FIG. 2.

The roof assembly 300 includes an inner roof sheet 360, an outer roof sheet 346, plurality of spaced apart roof bows 328, at least one LED light bar 326 mounted on the inner roof sheet 360, and a foamed core 329. The roof bows 328 are secured to the top rail 31b by known means, such as a rivet (not shown) extending through the roof bow 328 and the flange 43b. The outer roof sheet 346 sits on top of the roof bows 328 and the wall 41b of the top rail 31b. The outer roof sheet 346 is secured to the top rails 31b by known means, such as rivets 47b extending through the outer roof sheet 346 and the fourth wall 41b. The outer roof sheet 346 is secured to the roof bows 328 by known means, such as adhesive. The inner roof sheet 360 is spaced from the roof bows 328 and is parallel to the outer roof sheet 346. The foam core 329 is provided between the inner roof sheet 360 and the roof bows 328 and between the inner roof sheet 360 and the outer roof sheet 346, and acts as a structural member.

A plurality of LED light bars 326 are provided in the roof assembly 300. Each LED light bar 326 is identical in configuration and construction to the LED light bars 126 utilized in the first embodiment of the roof assembly 100. Therefore, the configuration and construction of the LED light bars 326 will not again be repeated herein for brevity purposes, but it is to be understood that reference numerals in the three hundreds denoting elements of the LED light bars 326 utilized in the third embodiment of the roof assembly 300 are identical to like reference numerals in the one hundreds denoting elements of the LED light bars 126 utilized in the first embodiment of the roof assembly 100.

The elongated members 304 of the LED light bars 326 are sized to extend between the top rails 31b. The number of LED light bars 326 provided in the trailer 20b may vary as desired, but is typically dependent upon the length of the trailer 20b, defined as the distance from the front wall 26b to the rear doors (not shown), as well as the amount of light which is desired to be emitted into the interior 32b of the trailer 20b. The LED light bars 326 are preferably equally spaced from one another along the length of the trailer 20b, but the spacing between the LED light bars 326 may be varied as desired.

The inner roof sheet 360 has top and bottom surfaces 362 and 364. The inner roof sheet 360 is preferably a single sheet of material formed of any appropriate material, such as fiberglass reinforced plastic, a metal or a strong, thermoset or thermoplastic resin glass or other fiber-reinforced material, such as KEMLITE® material or BULITEX® material or the like, but is preferably lightweight and strong. The inner roof sheet 360 is sized to close off the interior 32b of the trailer 20b such that the bottom surface 354 of the inner roof sheet 360 will be exposed to the interior 32b of the trailer 20b. The outer roof sheet 346 is made of a suitable material, such as glass, aluminum or fiberglass.

The inner roof sheet 360 is provided with a plurality of apertures 366 provided therethrough, with the apertures 366 preferably being provided in a plurality of rows which extend along the width of the inner roof sheet 360 at spaced intervals to one another. The apertures 366 within each row are provided at spaced intervals to one another which correspond to the intervals at which the LED lights 302 are spaced from one another within the LED light bars 326. The apertures 351 may be formed in the inner roof sheet 360 by punching or drilling, or by any other acceptable manner known in the art.

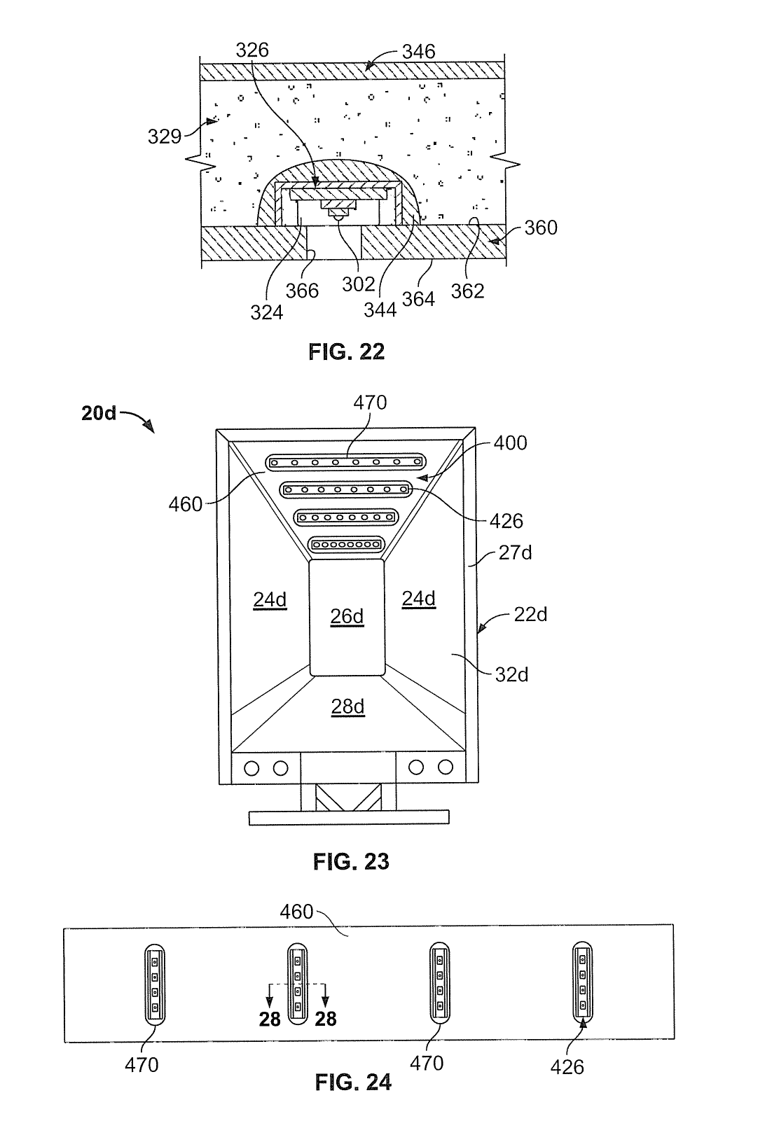

Each LED light bar 326 is positioned against the top surface 362 of the inner roof sheet 360, as illustrated in FIG. 22, and aligned with one of the rows of apertures 366 of the roof sheet 246. The leg portions 308 and 310 of the LED light bar 326 contact the top surface 362 of the inner roof sheet 360 such that the pieces of double pressure sensitive adhesive 324 are provided between and contact the top surface 362 of the inner roof sheet 360 and the base 306 of the elongated member 304. The LED lights 302 align with the apertures 366 in the row such that the LED lights 302 are visible through the apertures 366 from the bottom surface 364 of the inner roof sheet 360. Depending on the LED lights 302 used, the LED lights 302 may preferably be recessed back from the apertures 366, as illustrated in FIG. 22, or may extend into the apertures 366, but preferably do not extend out of the apertures 366 and into the interior 32b of the trailer 20b, as they may then be in position for damage as they would be positioned within the interior 32b of the trailer 20b.

The LED light bar 326 is covered by an adhesive 344, preferably tape, such as polypropylene, vinyl or mylar tape, as illustrated in FIG. 22. All of the LED light bars 326 are covered and secured to the top surface 362 of the inner roof sheet 360 in this manlier. The foam core 329 surrounds the adhesive 344 covering the LED light bar 326. The foam core 329 does not come into contact with the LED light bars 326 as the adhesive 338 separates the foam core 329 from the LED light bars 326. As such, the foam core 329 cannot move through the apertures 366 of the inner roof sheet 360. The foam core 329 fills the space between the outer roof sheet 346, the inner roof sheet 360 and the adhesive 338, and will preferably bond to all three and when dried or set, will become very rigid. The roof bows 328 do not extend close enough to the inner roof sheet 360 to impede the securement of the LED light bars 326 to the top surface 362 of the inner roof sheet 360.

The connector on the LED light bar 326 is connected to wiring 325 which extends outwardly from the end of the elongated member 304. As shown, the wiring 325 extends through a grommeted aperture provided through the wall 39b of the top rail 31b. A molded T-shaped connector 329 is secured to the top rail 31b in a groove provided at the juncture between the wall 39b and the wall 37b. The wiring 325 runs along the outer surface of the top rail 31b along the groove to a power source (not shown), which may be positioned appropriately on or in the trailer 20b, or on or in a cab (not shown) via the seven-way connector (not shown) which is used to pull the trailer 20b. With the power source supplying power to the wiring, the LED lights 302 are caused to emit light therefrom which is directed into the interior 32b of the trailer 20b in order to brighten the interior 32b of the trailer 20b.

It should be noted that, if desired, the elongated member 304 need not be provided with the leg portions 308, 310. In this instance, the pieces of double pressure sensitive adhesive 324 provided in the LED light bars 326 would contact the top surface 362 of the inner roof sheet 360. The adhesive 338 would cover the exterior surface 316 of the base 306 of the elongated member 304 and would close off accessibility to the LED light bars 326.

In each of the first, second and third embodiments, the wiring 125, 225 and 325 may be appropriately routed through the LED light bars 126, 226 and 326 and the roof structure 100, 200 and 300 so that the wiring 125, 225 and 325 is always contained within the trailer 20, 20a and 20b. This will prevent any potential leak paths.

Attention is invited to FIGS. 23-28 which shows the fourth embodiment of the roof assembly 400. The roof assembly 400 is provided with a plurality of LED light bars 426 for lighting an interior 32d of the trailer 20d, which is defined between the sidewalls 24d, the front wall 26d, the rear doors, the roof assembly 400 and the floor assembly 28d.

The roof assembly 400 is identically formed to that of the third embodiment, with the exceptions noted herein. Therefore, the configuration and construction of the roof assembly 400 will not again be repeated herein for brevity purposes, but it is to be understood that reference numerals in the four hundreds denoting elements of the roof assembly 400 utilized in the fourth embodiment of the roof assembly 400 are identical to like reference numerals in the three hundreds denoting elements of the roof assembly 300 utilized in the third embodiment of the roof assembly 300. In the roof assembly 400, the ceiling liner 460 is not flat, and instead includes a plurality of recesses 470 therein. The LED light bars 426 are not provided on the top surface 462 of the ceiling liner 460 and instead are mounted by the pieces of adhesive 424 to the bottom surface 464 of the ceiling liner 460.

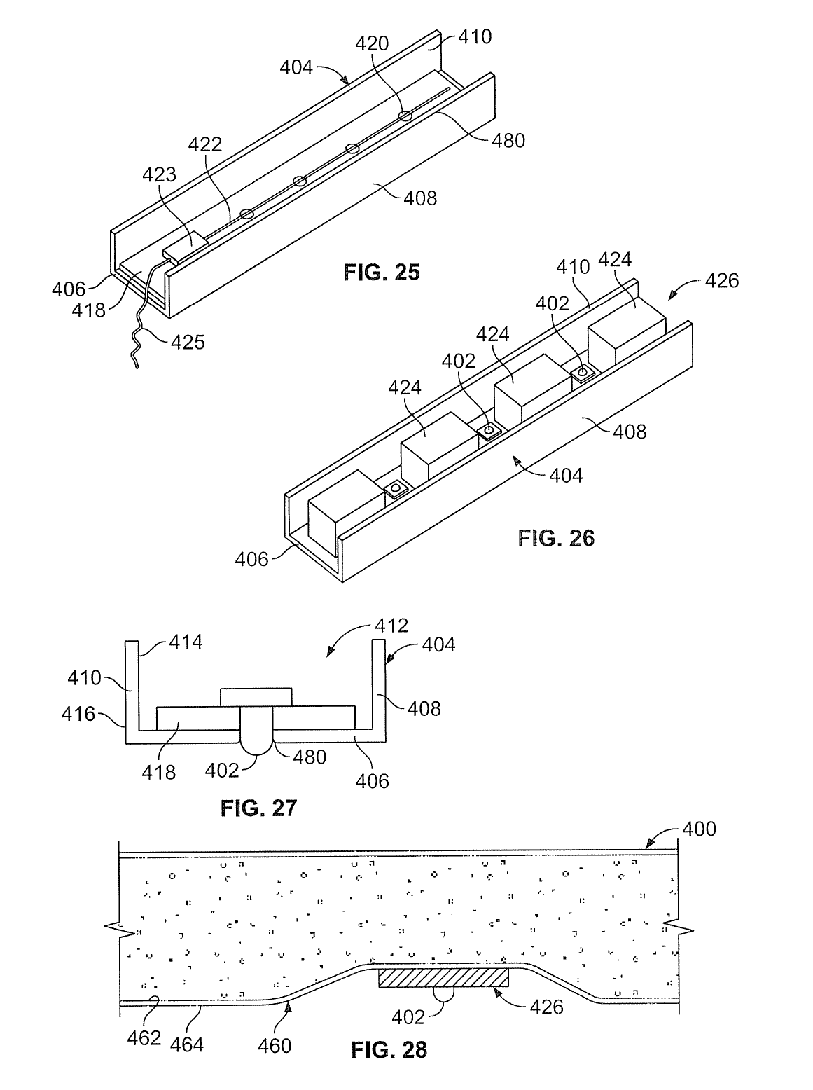

Each LED light bar 426 includes an elongated members 404 which are identical in configuration to the elongated members 104 utilized in the first embodiment of the roof assembly 100, except that the elongated members 404 are provided with a plurality of apertures 480 through the base 406, as illustrated in FIGS. 25 and 27. The apertures 480 are provided at spaced intervals to one another. The apertures 480 may be formed in the base 406 by punching or drilling, or by any other acceptable manner known in the art.

If the elongated member 404 is formed of a conductive material, such as the extruded aluminum of the preferred embodiment, an insulator 418 is provided on the interior surface 414 of the base 406 along the length of the elongated member 404. The insulator 418 may be applied around the apertures 480, or may also be applied to the walls defined by the apertures 480. The insulator 418 is preferably applied in a thin layer over the base 406 and is a non-conductive material, such as paint, tape or plastic. Although not illustrated, the insulator 418 may also be applied to at least a portion of the leg portions 408, 410 if desired. Where the elongated member 404 is formed of a non-conductive material, the insulator 418 need not be applied to the interior surface 414 of the base 406 or the leg portions 408 and 410.

As illustrated in FIG. 25, a circuit 420 is provided, such as by printing, on either the insulator 418 or the interior surface 414 of the base 406, as appropriate, along the length of the elongated member 404 by known means. Wiring 422 is connected to the circuit 420 at one of the two ends of the elongated member 404, and is connected to a connector 423 which is provided proximate to an end of the elongated member 402. The connector 423 is connected to wiring 425 which extends outwardly from the end of the elongated member 404, as illustrated in FIG. 25. The wiring 425 extends through a grommeted aperture (not shown) through the ceiling liner 460 proximate the end of the elongated member 404 a power source (not shown), which may be positioned appropriately on or in the trailer 20b, or on or in a cab (not shown) via the seven-way connector (not shown) which is used to pull the trailer 20b. With the power source supplying power to the wiring 425, the LED lights 402 are caused to emit light therefrom which is directed into the interior 32d of the trailer 20d in order to brighten the interior 32d of the trailer 20d.

The LED lights 402 are secured to either the insulator 418 or to the base 406 of the elongated member 404 by known means, such that the LED lights 402 are in connection with the circuit 420 and such that the LED lights 402 are visible through the apertures 480 of the base 406 from the exterior surface 416 of the base 406 of the elongated member 404. The LED lights 402 preferably extend a distance from the circuit 420 such that they are provided within or are even with the confines of the channel 412 of the elongated member 404, or may extend into the apertures 480 of the base 406, as shown in FIG. 27. Preferably, the LED lights 402 do not extend out of the apertures 480 and into the interior 32d of the trailer 20d, as they may then be in position for damage as they would be positioned within the interior 32d of the trailer 20d.

Pieces of adhesive 424, preferably double pressure sensitive adhesive, such as a foamed tape, for instance a 3M® Very High Bond (VHB) Tape, are secured to either the insulator 418 or the base 406, as appropriate, within the channel 412 between each of the LED lights 402, as illustrated in FIG. 26.

The LED light bar 426 includes the combination of the elongated member 404, the insulator 418 (if provided), the circuit 420, wiring 422 and connector 423, the LED lights 402, and the pieces of double pressure sensitive adhesive 424. The roof assembly 400 can include a plurality of LED light bars 426, the number of which are dependent upon the number of recesses 470 provided. The LED light bars 426 are mounted by the pieces of adhesive 424 to the bottom surface 464 of the ceiling liner 460. A lower boundary of the LED light bar 426 will preferably not extend below the bottom surface 464 of the ceiling liner 460 where the recesses 470 are not provided. The LED light bars 426 being positioned within these recesses 470 thus reduces the possibility of the LED light bars 426 being damaged by activity within the interior 32d of the trailer 20d. This embodiment provides a simpler installation and maintenance than the other embodiments.

It should be noted that, if desired, the elongated member 404 need not be provided with the leg portions 408 and 410, although this is not a preferred embodiment of the invention. Also, other or additional means of securing the LED light bars 426 to the bottom surface 464 of the ceiling liner 460.

The use of the LED lights 102, 202, 302 and 402 and the structure of the roof assemblies 100, 200, 300 and 400 having the LED lights 102, 202, 302 and 402 provided therein, provides a number of advantages over the prior art lighting that has typically been used in trailers, namely fluorescent and incandescent lighting. For instance, LED lights provide a lifetime product with lower power draw that would eliminate heavier dome lights. The LED lights also eliminate the need for dome light bracketry and reduces/eliminates snagging issues caused by the prior art lighting. LED lights require less maintenance and also reduces wire overloads. LED lights provide improved packaging compared to prior art lighting. Also, the prior art lighting typically does not respond well to cold temperatures. As the interior of a refrigerated semi-trailer at the ceiling thereof will typically have a temperature of −20 degrees Fahrenheit, prior art lighting has been known to fail or malfunction because of the cold temperatures. LED lights, however, do not present such problems in cold temperatures. Likewise, the LED lights do not require as much power as the prior art lighting, especially in cold temperatures. The weight of the LED lights and the structure needed to provide same also is less than that needed to provide the prior art lighting. The LED lights also do not require wires of as large a size as are used in prior art lighting. The LED lights also do not require as much maintenance as do the prior art lighting. Finally, the LED lights may be left on without a real concern that they may cause a fire, whereas prior art lighting could not be left on for extended periods of time because of this concern.

It should further be noted that the configuration of the roof bows 128 and 228 is a preferred configuration of the roof bows 128 and 228. The configuration of the roof bows 128 and 228 can, of course, be altered in keeping with the spirit of the invention.

While preferred embodiments of the present invention are shown and described, it is envisioned that those skilled in the art may devise various modifications of the present invention without departing from the spirit and scope of the appended claims.

The invention claimed is:

1. A roof structure for a trailer comprising:
a roof sheet;
a roof bow attached to said roof sheet; and
a member attached to one of said roof sheet and said roof bow, said member having a plurality of LED lights attached thereto.

2. A roof structure as defined in claim 1, wherein said roof sheet is attached to an upper end of said roof bow and said member is positioned between said roof sheet and said roof bow.

3. A roof structure as defined in claim 2, wherein member is attached to said roof bow, said LED lights being attached to an interior surface of said member which faces said roof bow, said roof bow including a plurality of apertures with which respective ones of said LED lights align.

4. A roof structure as defined in claim 3, further including adhesive covering an exterior surface of said member.

5. A roof structure as defined in claim 3, further including adhesive for attaching said member to said roof bow, said adhesive being provided between said interior surface of said member and said roof bow.

6. A roof structure as defined in claim 5, further including adhesive covering an exterior surface of said member.

7. A roof structure as defined in claim 2, further including a circuit attached to said plurality of LED lights.

8. A roof structure as defined in claim 7, further including a top rail attached to said roof bow and said roof sheet, said circuit extending through an aperture in said top rail.

9. A roof structure as defined in claim 2, wherein said member is conductive and further including an insulator provided on said member and a circuit provided on said insulator, said LED lights being provided on said insulator and attached to said circuit.

10. A roof structure as defined in claim 9, further including a top rail attached to said roof bow and said roof sheet, said circuit extending through an aperture in said top rail.

11. A roof structure as defined in claim 1, wherein member is attached to an exterior surface of said roof sheet, said LED lights being attached to an interior surface of said member which faces said roof sheet, said roof sheet including a plurality of apertures with which respective ones of said LED lights align.

12. A roof structure as defined in claim 11, further including adhesive covering an exterior surface of said member.

13. A roof structure as defined in claim 11, further including adhesive for attaching said member to said roof sheet, said adhesive being provided between said interior surface of said member and said roof sheet.

14. A roof structure as defined in claim 13, further including adhesive covering an exterior surface of said member.

15. A roof structure as defined in claim 11, further including a circuit attached to said plurality of LED lights.

16. A roof structure as defined in claim 15, further including a top rail attached to said roof bow and said roof sheet, said circuit extending through an aperture in said roof sheet and said top rail.

17. A roof structure as defined in claim 11, wherein said roof sheet is attached to a lower end of said roof bow and said member is positioned between said roof sheet and said roof bow.

18. A roof structure as defined in claim 17, further including a cap provided on ends of the roof bow.

19. A roof structure as defined in claim 11, wherein said member is conductive and further including an insulator provided on said member and a circuit provided on said insulator, said LED lights being provided on said insulator and attached to said circuit.

20. A roof structure as defined in claim 19, further including a top rail attached to said roof bow and said roof sheet, said circuit extending through an aperture in said top rail.

21. A roof structure as defined in claim 11, wherein said roof sheet is an inner roof sheet and further including an outer roof sheet and insulation provided between said inner roof sheet and said outer roof sheet, said roof bow being attached to said outer roof sheet and being attached to said inner roof sheet by said insulation, said roof bow generally being encapsulated by said insulation.

22. A roof structure as defined in claim 21, further including adhesive covering an exterior surface of said member, said insulation generally encapsulating said adhesive.

23. A roof structure as defined in claim 1, wherein member is attached to an interior surface of said roof sheet, said LED lights being attached to an interior surface of said member which faces said roof sheet, said member including a plurality of apertures with which respective ones of said LED lights align.

24. A roof structure as defined in claim 23, further including adhesive for attaching said member to said roof sheet, said adhesive being provided between said interior surface of said member and said roof sheet.

25. A roof structure as defined in claim 23, further including a circuit attached to said plurality of LED lights.

26. A roof structure as defined in claim 23, wherein said member is conductive and further including an insulator provided on said member and a circuit provided on said insulator, said LED lights being provided on said insulator and attached to said circuit.

27. A roof structure as defined in claim 23, wherein said roof sheet is an inner roof sheet and further including an outer roof sheet and insulation provided between said inner roof sheet and said outer roof sheet, said roof bow being attached to said outer roof sheet and being attached to said inner roof sheet by said insulation, said roof bow generally being encapsulated by said insulation.

28. A roof structure as defined in claim 23, further including a recess in said roof sheet in which said member is seated.
